(19) United States
(12) Patent Application Publication
(10) Pub. No.: US 2011/0100153 A1
(43) Pub. Date: May 5, 2011

(54) Accelerator Pedal Assembly

(76) Inventors: Murray Kaijala, Eikhart, IN (US); David Stewart, Malton (GB)

(21) Appl. No.: 12/873,878

(22) Filed: Sep. 1, 2010

Related U.S. Application Data
(63) Continuation-in-part of application No. 12/151,652, filed on May 8, 2008.
(60) Provisional application No. 61/275,737, filed on Sep. 2, 2009.

(51) Int. Cl. G05G 1/30

(52) U.S. Cl. 74/512

(57) ABSTRACT

A pedal assembly including a pedal housing and a friction generating cartridge which is clipped into the interior of the pedal housing through an opening in the base of the pedal housing. The cartridge includes at least an actuator engaged by a pedal arm, a brake pad engaged by the actuator, and springs which engage against the brake pad. Legs on the brake pad frictionally engage against interior surfaces of the cartridge. A flexible, arcuate rib member connects the legs. Feet at the end of the legs engage against the actuator and facilitate the flexing of the legs. A connector assembly extends through another opening in the housing and includes arms which clip the connector to the housing. In one embodiment, an elongate plate on the pedal arm engages a ledge defined on a back wall of the housing to limit the rotation of the pedal arm.

### CROSS-REFERENCE TO RELATED APPLICATIONS

This application is a continuation-in-part application of, and claims the benefit of the filing date of, U.S. patent application Ser. No. 12/151,652 filed on May 8, 2008, and titled “Accelerator Pedal for a Vehicle”. This application also claims the benefit of the filing date of U.S. Provisional Patent Application Ser. No. 61/275,737 filed on Sep. 2, 2009, the disclosures of which are explicitly incorporated herein by reference as are all references cited therein.

### FIELD OF THE INVENTION

This invention relates to a pedal mechanism and, in particular, a vehicle accelerator pedal.

### BACKGROUND OF THE INVENTION

Automobile accelerator pedals have conventionally been linked to engine fuel subsystems by a cable, generally referred to as a Bowden cable. While accelerator pedal designs vary, the typical return spring and cable friction together create a common and accepted tactile response for automobile drivers. For example, friction between the Bowden cable and its protective sheath otherwise reduces the foot pressure required from the driver to hold a given throttle position. Likewise, friction prevents road bumps felt by the driver from immediately affecting throttle position.

The mechanical cable-driven throttle systems, however, are now being replaced with a more fully electronic, sensor-driven approach. With the fully electronic approach, the position of the accelerator pedal is read with a position sensor and a corresponding position signal is made available for throttle control. A sensor-based approach is especially compatible with electronic control systems in which accelerator pedal position is one of the several variables used for engine control.

Although such drive-by-wire configurations are technically practical, drivers have generally preferred the feel, i.e., the tactile response, of conventional cable-driven throttle systems. Designers have therefore attempted to address this preference with mechanisms in the electronic pedal assemblies which emulate the tactile response of cable-driven accelerator pedals. For example, U.S. Pat. No. 6,360,631 to Wortmann et al. is directed to an accelerator pedal with a plunger subassembly for providing a hysteresis effect.

In this regard, prior art systems are either too costly or inadequately emulate the tactile response of conventional accelerator pedals. Thus, there continues to be a need for a cost-effective, electronic accelerator pedal assembly having the feel of cable-based systems.

### SUMMARY OF THE INVENTION

The present invention is directed to a pedal assembly comprising a housing, a pedal arm coupled to the housing, a friction generating assembly associated with the housing and a sensor responsive to movement of the pedal arm for providing an electrical signal that is representative of pedal position.

The friction generating assembly includes an actuator which is mounted adjacent the pedal arm and is adapted to be moved by the pedal arm as the pedal arm is depressed. The friction generating assembly also includes a brake pad having a pair of legs interconnected by a flexible and arcuate rib member. Each of the legs includes an interior and an exterior contact surface and the actuator is adapted to abut against the interior contact surface of the pair of legs and flex the pair of legs and the exterior contact surface thereof into abutting frictional abutting relationship with a braking surface. The friction generating assembly also includes at least one spring which contacts the brake pad for biasing the pedal arm.

In one embodiment, each of the pair of legs of the brake pad includes a distal foot projecting outwardly therefrom and the actuator is adapted to abut against the distal foot on each of the legs and flex the pair of legs outwardly away from each other and into contact with the braking surface.

Further, in one embodiment, the friction generation assembly includes a housing which defines the braking surface and receives the actuator and the brake pad for linear movement therein and the spring for compression therein.

Still further, in one embodiment, the pedal assembly housing defines an interior cavity and includes a base defining an opening in a lower surface thereof and the friction generating assembly is in the form of a separate cartridge which is fitted into the interior cavity of the pedal assembly housing through the opening in the base of the pedal assembly housing.

Moreover, in one embodiment, the pedal assembly housing defines an other opening into the interior thereof and the pedal assembly further comprises a connector assembly which extends through the other opening and into the interior cavity and includes a pair of dip arms for clipping the connector assembly to the pedal assembly housing.

Additionally, in one embodiment, the pedal assembly housing includes a back wall defining an interior ledge and the pedal arm includes a drum and an elongated arm protruding outwardly therefrom and adapted to abut against the interior ledge defined on the back wall of the pedal assembly housing for limiting the rotation of the pedal arm relative to the pedal assembly housing.

These and other objects, features and advantages will become more apparent in light of the text, drawings and claims.

### BRIEF DESCRIPTION OF THE DRAWINGS

These and other features of the invention can best be understood by the following description of the accompanying drawings as follows:

FIG. 1 is an exploded perspective view of an accelerator pedal assembly in accordance with the present invention incorporating a friction generating assembly or module also in accordance with the present invention;

FIG. 2 is a vertical cross-sectional view of the accelerator pedal assembly of FIG. 1;

FIG. 3 is an enlarged perspective view of the friction generating module of the accelerator pedal assembly shown in FIGS. 1 and 2;

FIG. 4 is an enlarged exploded perspective view of the friction generating module shown in FIG. 3;

FIG. 5 is an enlarged perspective view of the brake pad of the friction generating module shown in FIGS. 3 and 4;

FIG. 6 is an enlarged horizontal cross-sectional view of the friction generating module shown in FIG. 3;

FIG. 7 is a vertical cross-sectional view of an alternate embodiment of an accelerator pedal assembly in accordance with the present invention; and

FIG. 8 is an exploded perspective view of the pedal arm of the accelerator pedal assembly shown in FIG. 7.

### DETAILED DESCRIPTION OF THE EMBODIMENTS

While this invention is susceptible to embodiment in many different forms, this specification and the accompanying drawings disclose two accelerator pedal assembly embodiments as examples of the invention. The invention is not intended to be limited to the embodiments so described, however. The scope of the invention is identified in the appended claims.

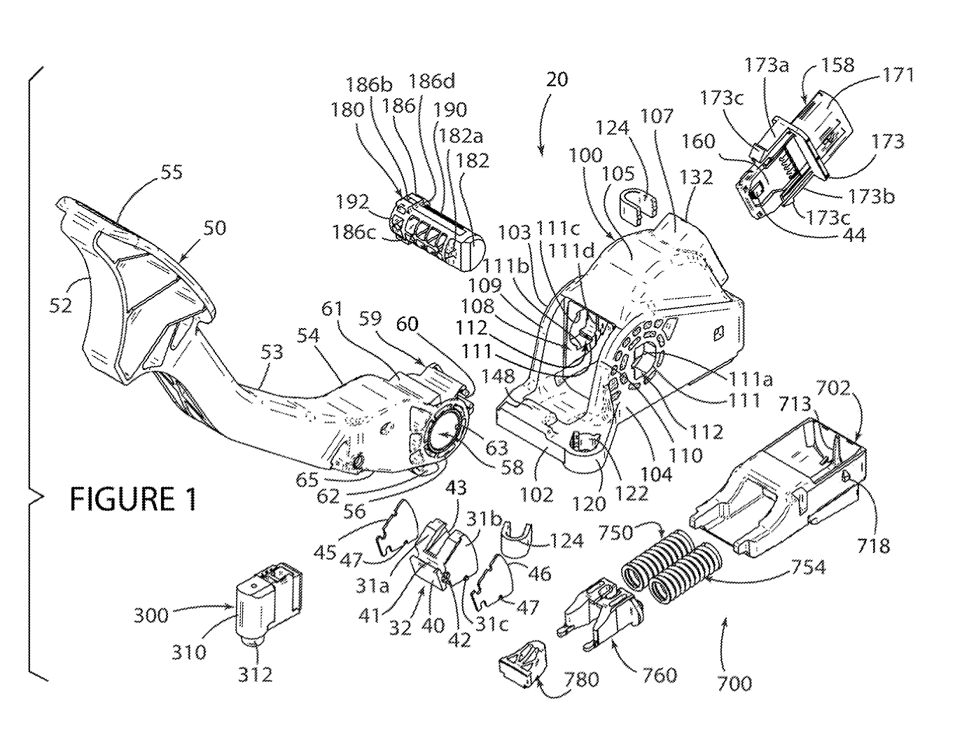

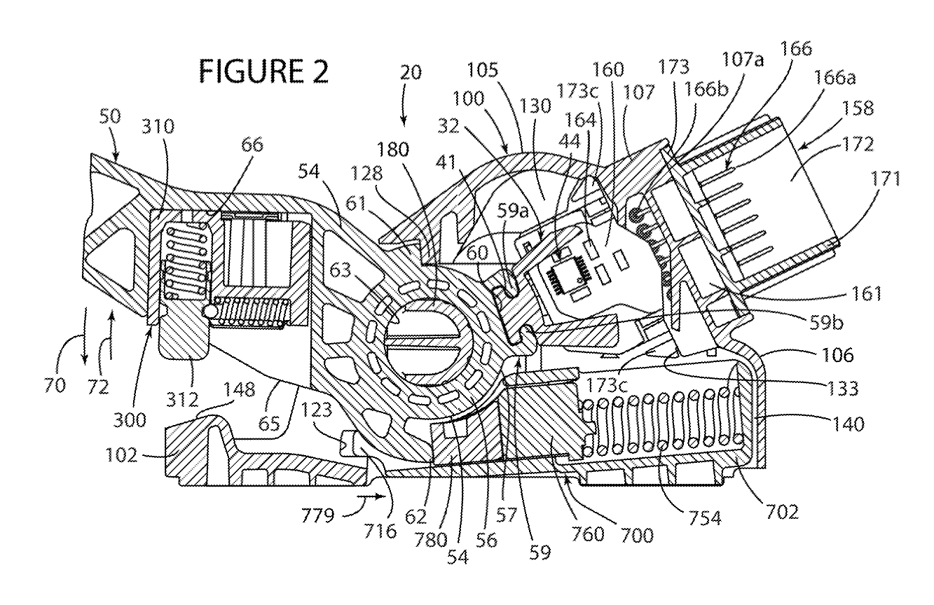

A first embodiment of a non-contacting accelerator pedal assembly 20 in accordance with the present invention incorporating a friction generating assembly or module 700 also in accordance with the present invention is shown in FIGS. 1 and 2.

Pedal assembly 20 incorporates features which are currently the subject of U.S. Published Patent Application No. US2008/0276749 and thus the disclosure thereof is expressly incorporated herein by reference. Pedal assembly 20 includes a pedal housing 100 and an elongated pedal arm 50 that is rotatably mounted to and in the pedal housing 100. The housing 100 defines a cavity which contains the friction module 700 and the pedal assembly 20 is adapted for mounting to the firewall or floor of a vehicle (not shown).

The pedal assembly 20, including the housing 100 thereof, can be formed from any suitable molded plastic and the housing 100 defines an enclosure or shell including a generally flat bottom housing wall or base 102 (FIGS. 1 and 2), generally curved side walls 103 and 104 (FIG. 1), a top generally curved housing wall or roof or cover 105 (FIGS. 1 and 2), and a back housing wall 106 (FIG. 2). Side walls 103 and 104 are generally parallel and opposed and spaced from each other and are oriented generally perpendicular to, and extend unitarily from, the opposed side edges of the base 102 and the roof 105.

The base 102 and the walls 103, 104, 105, and 106 of the pedal housing 100 together define an interior hollow sensor cavity 130 (FIG. 2) and an interior friction generating assembly or module cavity 140 (FIG. 2) located below the sensor cavity 130. The cavities 130 and 140 are accessible through respective openings (not shown) in the back wall 106 and the lower surface of the base 102 of the housing 100.

Pedal housing 100 further defines a front opening 108 (FIG. 1) for the pedal arm 50. The side walls 103 and 104 include respective arc- or curved-shaped exterior shoulders or edges 109 and 110 (FIG. 1) with respective lower ends which merge into the top surface of the base 102. The upper ends of the arc-shaped shoulders 109 and 110 merge into the top housing wall 105. The shoulders 109 and 110, the top face of the base 102, and the front edge of the top wall 105 together define the pedal opening 108 defined in the front of the housing 100.

Further, an interior wall 111 in each of the side walls 103 and 104 and, more specifically, in each of the shoulders 109 and 110 thereof, defines a shaft bore 112. Shaft bores 112 are co-linear with each other. Interior wall 111 in housing side wall 104 further defines a groove or notch 111a. Interior wall 111 in opposed housing side wall 103 further defines a plurality of spaced-apart grooves or notches 111b, 111c, and 111d.

A pair of anchors 120 (only one of which is shown in FIG. 1) extend outwardly from respective opposed corners of the housing base 102. Each anchor 120 defines an aperture 122. A generally U-shaped metal insert 124 (FIG. 1) is press-fit into the aperture 122. Housing 100 is securable to a vehicle using fasteners such as bolts or screws (not shown) that pass through the inserts 124 and the apertures 122 and into the firewall or a pedal rack of the vehicle.

The interior surface of the housing base 102 additionally defines a pair of spaced-apart recesses or grooves 123 (only one of which is shown in FIG. 2) for clipping or hooking the friction generating module 700 in the interior of the housing 100 as described in more detail below. Additionally, a wedge-shaped protrusion or platform 148 (FIGS. 1 and 2) extends and slopes upwardly from the top surface of the housing base 102 in the direction of the pedal arm opening 108.

A connector mounting flange 107 (FIGS. 1 and 2) extends outwardly from the top housing wall 105 and the back housing wall 106. Connector mounting flange 107 defines an opening (not shown) that is contiguous with and extends through the back housing wall 106 and into the interior sensor cavity 130. The interior surface of connector mounting flange 107 defines an interior shoulder or step 133 (FIG. 2).

Elongated pedal arm 50 has a proxil end 54 (FIGS. 1 and 2) and a distal end 52 (FIG. 1). An elongate center portion 53 (FIG. 1) extends between the ends 52 and 54. Pedal arm 50 has a bottom side or surface 65 (FIGS. 1 and 2). Distal end 52 defines a top footpad 55 (FIG. 1) which may be either integral with the pedal arm 50 or articulating and rotating at its connection to distal end 52. Pedal arm 50 can also be made from an injection molded plastic or the like suitable material.

Proxil end 54 terminates in a rounded drum 56 (FIGS. 1 and 2) that presents a curved, convex surface 57 (FIG. 2). An interior cylindrical wall 63 (FIGS. 1 and 2) defines a through-bore 58 (FIG. 1) which extends through the drum 56. When pedal arm 50 is extended into the opening 108 and mounted in the sensor cavity 130 of housing 100, bore 58 is contiguous and coaxial with the bores 112 defined in the respective side walls 103 and 104.

A bracket 59 (FIGS. 1 and 2) is also defined on the drum 56 by a pair of generally L-shaped spaced-apart hooks or fingers 59a and 59b (FIG. 2) which protrude outwardly from a front portion of the surface 57 of the drum 56 and together define a recess or pocket 60 (FIGS. 1 and 2).

A shoulder or stop 61 (FIGS. 1 and 2) projects outwardly from an upper portion of the drum 56 located above the bracket 59 and a rounded cam lobe or finger 62 (FIGS. 1 and 2) extends from a bottom portion of the drum 56 located below the bracket 59. In the embodiment shown, the stop 61 and the finger 62 are located generally opposite and co-linear with each other.

Pedal arm 50 is retained in, and pivots about, the pedal housing 100 via an elongate axle or shaft 180 (FIGS. 1 and 2) that extends through the bore 58 in the drum 56 and the bores 112 in housing side walls 103 and 104. Axle or shaft 180 is cylindrical in shape and defines a distal end 182 (FIG. 1) and a proximal end or head 186 (FIG. 1) having a diameter greater than the distal end 182. A round bearing surface or portion 190 (FIG. 1) is located on axle 180 between ends 182 and 186. Distal end 182 includes an outwardly projecting tab 182a (FIG. 1). Proximal head 186 defines a plurality of outwardly protruding spaced-apart tabs 186b, 186c, and 186d.

The distal end 182 of axle 180 is press-fit (not shown) into the interior surface 111 of housing side wall 104 in a relationship wherein the tab 182a thereof is fitted into the groove 111a to prevent the rotation of the axle 180 relative to the side wall 104. Similarly, and although not shown in any of the FIGURES, the distal end 186 of the axle 180 is press-fit into the interior surface 111 of the side wall 103 in a relationship wherein the tabs 186b, 186c, and 186d are fitted into the respective grooves 111b, 111c, and 111d also again to prevent the rotation of the axle 180 relative to the side wall 103.

Thus, pedal arm 50 rotates in the opening 108 of housing 100 about the stationary axle 180. Specifically, pedal arm 50 is rotatable in a clockwise direction (arrow 72 in FIG. 2) relative to and about the housing 100 until the stop 61 contacts a ridge or lip or shoulder 128 formed on and projecting downwardly from the interior surface of the top housing wall 105. The lip 128 is located adjacent the opening 108 in pedal housing 100. Pedal arm 50 is also rotatable counter-clockwise (arrow 70 in FIG. 1) about the housing 100 until the pedal arm 50 reaches another rotational limit at an open-throttle position where the bottom side 65 of the pedal arm 50 contacts the base 102 of the housing 100.

The pedal assembly 20 additionally comprises a sensor assembly defined by the combination of a bipolar tapered magnet assembly or magnet 32 (FIGS. 1 and 2) which is attached to the pedal arm 50 and extends into the sensor cavity 130 in the housing 100, a magnetic field sensor 44 (FIGS. 1 and 2) in the interior of the housing 100, and magnetic flux conductors or pole pieces 45 and 46 (FIG. 1) coupled to the magnet 32.

Magnet assembly 32 comprises a pair of parallel, spaced-apart, and opposed generally fan-shaped magnet sections or vertical walls 31a and 31b (FIG. 1) and a mushroom-shaped stem or base portion 40 therebetween. Stem portion 40 defines recesses 41 and 42 that extend transversely across the magnet assembly 32. A sensor slot 43 is defined between the spaced-apart magnet assembly walls 31a and 31b. Magnet assembly 32 is secured to the drum 56 as shown in FIG. 2 by sliding the stem or base portion 40 thereof into the pocket 60 of the bracket 59 on the drum 56 in a relationship wherein the bracket fingers 59a and 59b extend into the magnet assembly recesses 41 and 42 respectively and the exterior surface of the base portion 40 of magnet assembly 32 is abutted against the exterior surface of the drum 56. Each of the magnet assembly walls 31a and 31b additionally includes at least one outwardly protruding tab 31c (FIG. 1 shows only the tab 31c on the wall 31b).

Magnetic flux conductors or pole pieces 45 and 46 are fan-shaped, are preferably made of steel, define a pair of respective grooves 47 defined in the upper and lower edges thereof, and are mounted on respective opposed sides of the magnet 32. Specifically, flux conductor 45 is abutted against and mounted to the outside surface of the magnet section 31a while the flux conductor 46 is abutted against and mounted to the outside surface of the magnet section 31b in a relationship wherein the respective tabs 31c on the walls 31a and 31b are fitted into the respective grooves 47 in the pole pieces 45 and 46.

Further details of the use and construction of the magnet assembly 32 can be found in U.S. Pat. No. 6,211,668 entitled “Magnetic Position Sensor Having Opposed Tapered Magnets”, the contents of which are herein incorporated by reference in their entirety.

The magnet assembly 32 and the sensor 44 are mounted in the interior of the housing 100 in a relationship as shown in FIG. 2 wherein the sensor 44 is located in and protrudes into the slot 43 defined between the magnet assembly walls 31a and 31b. The magnet assembly 32 creates a variable magnetic field that is detected by the magnetic field sensor 44 which, in the embodiment shown, is a Hall effect sensor. The magnet assembly 32 and the sensor 44 provide an electrical signal that is representative of the rotational position or displacement of the pedal arm 50 relative to the housing 100. In one embodiment, the magnetic field sensor 44 may be a single Hall effect component or device. In another embodiment, the magnetic field sensor 44 may be an integrated circuit commercially available from Melexis Corporation of leper, Belgium.

Hall effect sensor 44 is responsive to flux changes induced by the pedal arm displacement and the corresponding displacement of the magnet assembly 32. Electrical signals from the sensor 44 have the effect of converting the displacement of the pedal arm 50, as indicated by the displacement of the magnet assembly 32, into a dictated speed/acceleration command which is communicated to an electronic control module such as is shown and described in U.S. Pat. Nos. 5,524,589 to Kikkawa et al. and 6,073,610 to Matsumoto et al., the disclosures of which are hereby expressly incorporated herein by reference.

In the embodiment shown, the Hall effect sensor 44 is mounted to a generally planar printed circuit board 160 (FIGS. 1 and 2) which includes opposed side surfaces (only one of which is shown in FIGS. 1 and 2). Hall effect sensor 44 is mounted, as by soldering or the like, to one of the side surfaces of the printed circuit board 160. The portion of the printed circuit board 160 including the sensor 44 likewise extends, as shown in FIG. 2, into the slot 43 defined between the magnet assembly walls 31a and 31b.

Other electronic components 164 (FIG. 2) including, for example, amplifiers and filters, can also be mounted to the side surface of the printed circuit board to allow the processing of the signals generated by the Hall effect sensor 44.

Hall effect sensor 44 is operably connected through the circuit board 160 to terminals 166 (FIG. 2) which are soldered to the printed circuit board 160. Terminals 166 define respective ends 166a and 166b. End 166b is soldered to the printed circuit board 160 while the end 166a extends into a cavity 172 defined in a connector assembly 158 (FIGS. 1 and 2). Terminal ends 166a are adapted to be mated to an external wiring harness (not shown) that is connected to an engine controller or computer in a vehicle.

Connector assembly 158 includes a generally rectangularly-shaped, circumferentially extending wall 171 (FIGS. 1 and 2) that defines an interior distal cavity 172 (FIG. 2). Terminal ends 166a extend into the cavity 172. Wall 171 terminates in an annular distal flange 173 (FIGS. 1 and 2) that surrounds and extends generally normally outwardly from the wall 171. A pair of opposed, elongate, flexible arms 173a and 173b (FIG. 1) project outwardly from the interior surface of the flange 173 and terminate in respective distal fingers 173c (FIGS. 1 and 2). Circuit board 160 is coupled to, and extends generally normally outwardly from, the front surface of the flange 173, and in a relationship generally co-planar with, the flexible arms 173a and 173b.

Connector assembly 158 and, more specifically, the printed circuit board 160 coupled thereto, extends through the opening (not shown) defined in the back wall 106 of the housing 100 and into the housing sensor cavity 132 as shown in FIG. 2. Initially, and although not shown in any of the FIGURES, it is understood that upon insertion of the connector assembly 158 in the housing 100, the arms 173a and 173b are flexed inwardly toward each other as a result of the contact thereof with the interior surface of the housing connector flange 107 and then flex or snap back away from each other when the finger 173c on respective flexible arms 173a and 173b clear the interior housing shoulder 133 to lock the connector assembly 158 to the housing 100. In its fully inserted position, the outside face of the flange 173 of the connector assembly 158 rests against an interior circumferential shoulder 107a (FIG. 2) defined on a peripheral circumferential edge of the connector mounting housing flange 107.

A cavity 66 (FIG. 2) extends from the bottom surface 65 of, and into the interior of, the center portion 53 of the pedal arm 50 at a location aft of the drum 59. A kickdown device 300 (FIGS. 1 and 2) is press-fitted into the cavity 66.

The kickdown device 300 includes a housing 310, a button 312, and a spring 314 located within, and protruding outwardly from, the housing 312. Kickdown device 300 and, more specifically, the button 312 thereof, is adapted to abut against the ledge 148 on the base wall 102 of the housing 100 in response to the counter-clockwise rotation of the pedal arm 50 to provide an increased resistance to pedal depression as described in more detail in U.S. Pat. No. 6,418,813, entitled “Kickdown Mechanism for a Pedal”, the contents of which are herein incorporated by reference in their entirety.

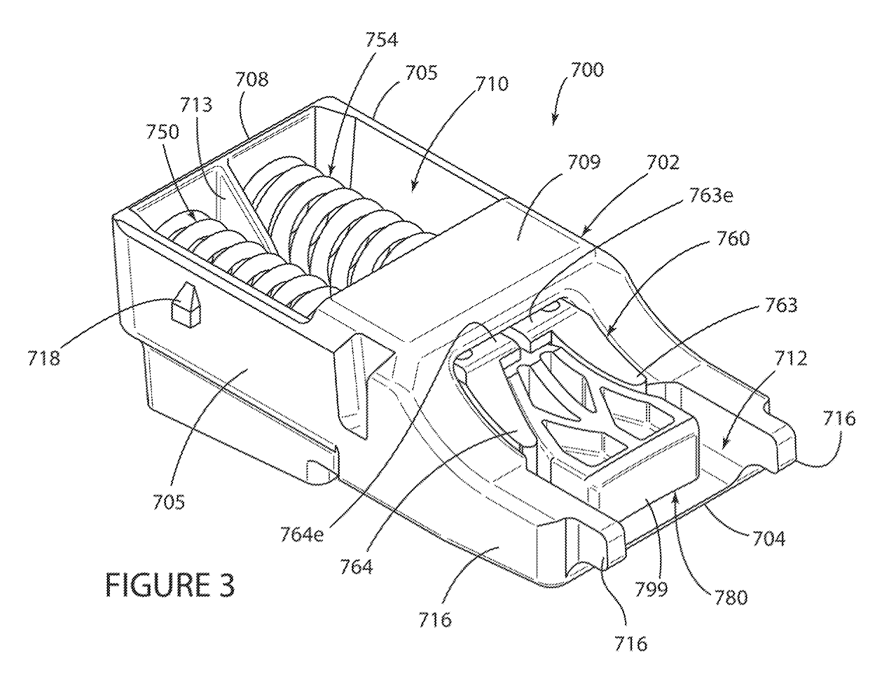

Friction generating assembly or cartridge or module 700 is shown in detail in FIGS. 3, 4, 5, and 6 and is adapted to be mounted in the friction generating assembly cavity 140 (FIG. 2) defined in the interior of the housing 100 adjacent the housing base wall 102. Friction generating assembly 700 includes a brake housing or cartridge or module 702 within which at least the following components are mounted: springs 750 and 754; a brake pad 760; and an actuator 780. As described in more detail below, the springs 750 and 754 abut against one end of the brake pad 760, one end of the actuator 780 extends into an opposite end of the brake pad 760, and the other end of the actuator 780 abuts against the pedal arm 50, i.e., the brake pad 760 is sandwiched in the housing 702 between the springs 750 and 754 and the actuator 780.

As shown in FIGS. 3, 4, and 6, brake housing 702 is generally rectangular and match box-shaped and includes a bottom wall or floor 704 that adjoins parallel opposed spaced-apart vertical side walls 705. A top wall or cross-member 709 connects the top of the side walls 705. Top wall 709 is opposed to and spaced from the floor 704. Top wall 709 adds additional strength to the side walls 705. Brake housing 702 includes a vertical distal back end wall 708 which is joined to the floor 704 and the side walls 705. The proximal end of the brake housing 702 opposite the distal end wall 708 is devoid of a wall and defines an opening 712.

Brake housing 702 may be formed from any suitable material such as an injection molded plastic and, more specifically, from a plastic having a high yield strength.

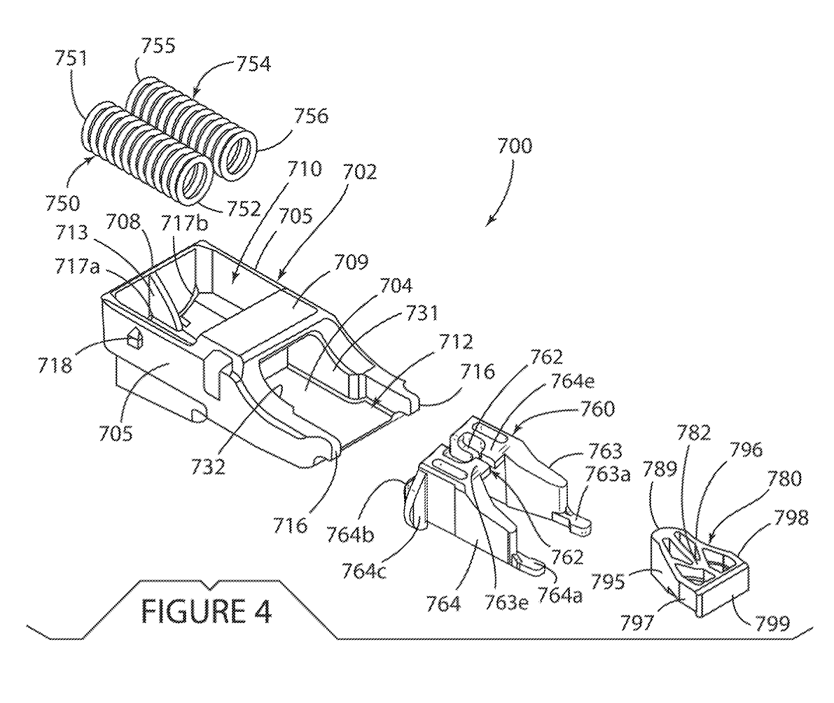

The floor 704, the side walls 705, and the back wall 708 together define an interior chamber or cavity 710 (FIGS. 3, 4, and 6). A pair of U-shaped ribs 717a and 717b (FIG. 4) protrude outwardly from the floor 704 and the back end wall 708 into the interior of the cavity 710. A center rib 713 (FIGS. 3, 4, and 6) extends upwardly from the floor 704 and outwardly from the distal end wall 708 into the cavity 710 and between the ribs 717a and 717b.

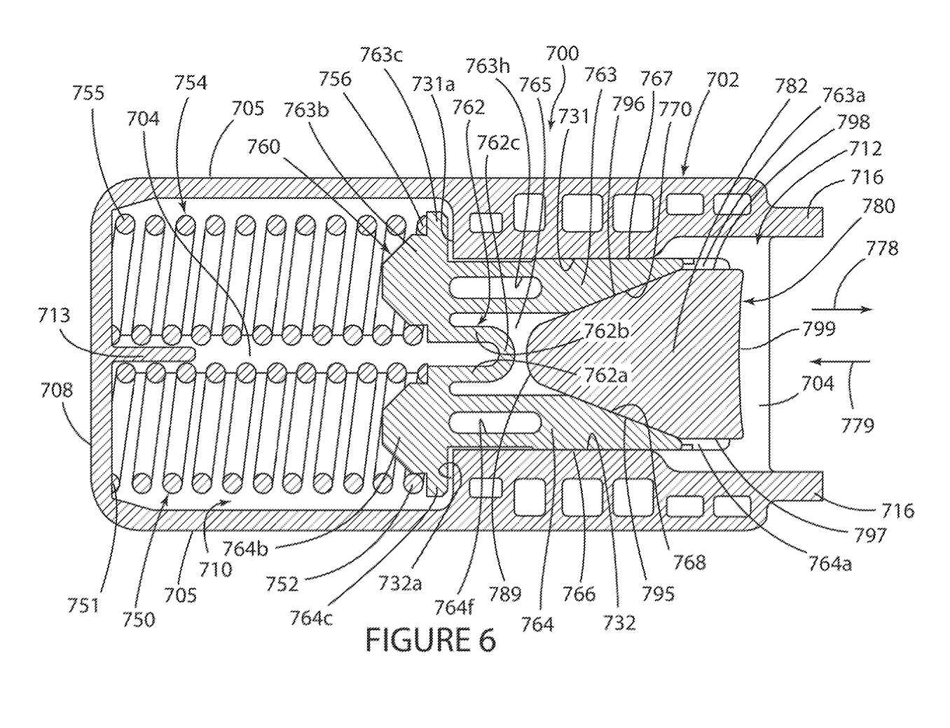

A portion of each of the opposed side walls 705 of the brake housing 702 located fore of the cross-member 709 is of increased thickness and extends or protrudes inwardly into the cavity 710 to define interior opposed, facing, parallel, flat interior braking surfaces 731 and 732 (FIGS. 4 and 6) and opposed interior shoulders 731a and 732a (FIG. 6) between and normal to the side walls 705 and the surfaces 731 and 732. The shoulders 731a and 732a face the back housing wall 708. The brake surfaces 731 and 732 may be formed of either the same material as the side walls 705 or may be formed from a material having an increased coefficient of friction.

Each of the side walls 705 additionally includes a ledge or extension or hook 716 (FIGS. 3, 4, and 6) protruding outwardly from a proximal edge thereof. The ledges 716 are opposed, spaced, and parallel to each other. A locking tab 718 (only one of which is shown is FIGS. 3 and 4) protrudes outwardly from the outside face of each of the side housing walls 705 and the distal back end wall 708.

The brake pad 760 is mounted in the cavity 710 of the brake housing 702 and is configured for engagement with the housing interior braking surfaces 731 and 732. Brake pad 760 comprises a pair of elongated, parallel, spaced-apart legs 763 and 764 and a flexible, generally arcuate (U-shaped) coupling rib member 762 (FIGS. 4, 5 and 6) therebetween which is unitary with and couples the two legs 763 and 764 together. Rib member 762 includes a pair of spaced-apart, generally parallel segments 762a and 762b including respective proximal ends which are coupled to the respective legs 763 and 764 and a central arcuate body member 762c unitary with and coupling the respective distal ends of the leg segments 762a and 762b. A slot 765 (FIG. 6) is defined between the legs 763 and 764.

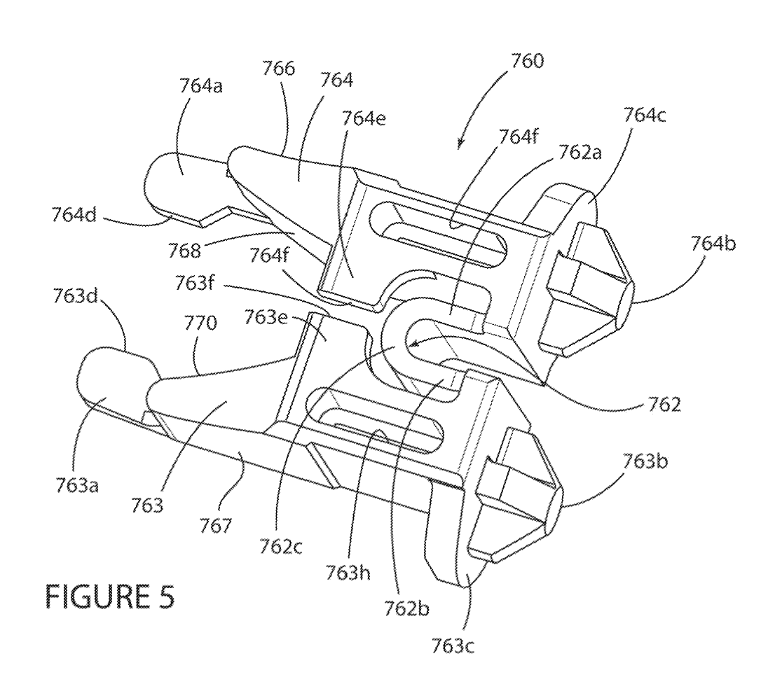

The leg 763 has a narrow or thin plate or paddle or foot 763a extending and protruding outwardly from a lower edge of the proximal end thereof. The leg 764 has a narrow or thin plate or paddle or foot 764a extending and protruding outwardly from a proximal end thereof. Plates 763a and 764a are diametrically opposed to and face each other and include respective diametrically opposed and facing interior flat, non-angled, non-sloped surfaces 763d and 764d (FIG. 5) respectively. In the embodiment shown, the lower surface of each of the plates 763a and 764b is co-planar with the lower surface of each of the respective legs 763 and 764.

Leg 763 has a flat, non-angled, non-sloped, outward-facing exterior contact surface 767 and an inward-facing flat angled, sloped interior surface 770 (FIGS. 5 and 6). Leg 764 has a flat, non-angled outward-facing, non-sloped exterior contact surface 766 and an inward-facing flat angled interior surface 768 (FIGS. 5 and 6). Angled interior surfaces 768 and 770 face each other and diverge outwardly from each other in the direction of the distal end plates 763a and 764a.

Flanges or shoulders 763c and 764c (FIGS. 4, 5, and 6) protrude generally normally outwardly from the ends of the legs 763 and 764 respectively opposite the ends thereof including the plates 763a and 764b. Heads 763b and 764b project outwardly from an exterior face of the respective flanges 763c and 764c (FIGS. 4, 5, and 6).

The legs 763 and 764 additionally include respective inwardly-facing tabs or wings 763e and 764e (FIGS. 4 and 5) defining respective end faces 763f and 764f (FIG. 5). In the normal unflexed position of the legs 763 and 764, the wings 763e and 764e are positioned in a spaced-apart, parallel, and opposed relationship and are located on the respective legs 763 and 764 between the respective plates 763a and 764a and the rib member 762. In the embodiment shown, the top surface of respective wings 763e and 764e is generally co-planar with the top surface of the respective legs 763 and 764. The legs 763 and 764 further define respective generally oval-shaped elongate recesses or grooves 763h and 764f (FIGS. 5 and 6) extending through the wings 763e and 764e respectively.

Brake pad 760 can be formed from any suitable material including any suitable plastic material adapted to provide the desired coefficient of friction with the contact surfaces 766 and 767 of the housing 702.

Brake pad 760 is located in the cavity 710 of the housing 702 and seated against the upper surface of the floor 704 of the housing 702 in a relationship wherein the flanges 763c and 764c of the brake pad 760 are located opposite and facing the shoulders 731a and 732a defined on the side walls 705 of the housing 702 (FIG. 6); the heads 763b and 764b of the legs 763 and 764 of the brake pad 760 face the back wall 708 of the housing 702 (FIG. 6); the outside/exterior surfaces 767 and 766 of the respective legs 763 and 764 are located opposite and abutted against the inside/interior housing surfaces 731 and 732 respectively of the side walls 705 of the housing 702 (FIG. 6); the wings 763e and 764e are located below and abutted against the interior surface of the top wall 708 of the housing 702 (FIG. 6); and the lower surface of the paddles 763a and 764a is abutted against the upper surface of the floor 704 of the housing 702 (FIG. 6).

The pair of coil springs 750 and 754 are also mounted in the cavity 710 of the brake housing 702 (FIGS. 3 and 6). Spring 750 defines opposed ends 751 and 752 (FIGS. 4 and 6). Spring 754 defines opposed ends 755 and 756 (FIGS. 4 and 6). Spring 750 is seated in the housing cavity 710 against the upper surface of the floor 704 of the housing 702 in a relationship sandwiched between the back housing wall 703 and the brake pad 760 wherein the end 755 thereof is abutted against the interior surface of the back end wall 708 of the housing 702, the opposite end 756 thereof is abutted against the outside surface of the flange 763c of the brake pad 760, and the head 763b of the leg 763 of the brake pad 760 extends into the end 756 of the spring 750.

In a like manner, the spring 750 is seated against the upper surface of the floor 704 in the housing cavity 710 of the housing 702 in a relationship sandwiched between the back housing wall 708 and the brake pad 760 and parallel and spaced from the spring 754 wherein the end 751 of the spring 750 is abutted against the interior surface of the back end wall 708 of the housing 702, the opposite end 752 thereof is abutted against the outside surface of the flange 764c of the brake pad 760, and the head 764b of the leg 764 of the brake pad 760 extends into the end 752 of the spring 750. Spring ends 751 and 755 are retained in housing 702 by resting on the respective U-shaped ribs 717a and 717b which are defined in the housing 702. The rib 713 in housing 702 is located between the springs 750 and 754.

Two springs are used for redundancy reasons. If one spring fails, the other remains operational. This redundancy is provided for improved reliability, allowing one spring to fail or fatigue without disrupting the biasing function. It is useful to have redundant springs and for each spring to be capable on its own of returning the pedal arm to its idle position. Other types of springs could also be used such as leaf springs or torsion springs.

The actuator 780 is located in the housing 702 and, more specifically, the housing cavity 710 thereof between the brake pad 760 and the brake housing opening 712 and, more specifically, extends into the slot 765 defined between the legs 763 and 764 of the brake pad 760 and, still more specifically, into a relationship wherein the actuator 780 is in contact with the interior surfaces or faces of the respective feet 763a and 764b and the legs 763 and 764 respectively of the brake pad 760 (FIG. 6).

Actuator 780 (FIGS. 3, 4, and 6) comprises a generally wedge-shaped body 782 including opposed proximal side angled wedging surfaces 795 and 796; opposed side non-angled surfaces 797 and 798 aft of the side angled wedging surfaces 795 and 796 respectively; a rounded, proximal end surface 789 fore of and joining the distal ends of the angled side surfaces 795 and 796; and a flat distal end surface 799 aft of and joining the proximal ends of the side surfaces 797 and 798. Side wedging surfaces 795 and 796 diverge outwardly from each other and the proximal end surface or tip 789 in a generally V-shaped orientation in the direction of actuator distal surface 799. The surface 799 of the actuator 780 is adapted to be engaged by the lobe 62 formed on the drum 56 of the pedal arm 50 as shown in FIG. 2.

As shown in FIG. 2, the friction generating assembly 700 is mounted in the friction generating assembly cavity 140 of the pedal housing 100 as a single, separate cartridge or modular unit. When the friction generating assembly 700 is pressed inwardly into the housing cavity 140 through the opening (not shown) defined in the bottom of the base 102 of the pedal housing 100, the respective hooks 716 at the end of the respective side walls 705 of the brake housing 700 are first inserted into the respective recesses 123 in the base 102 of the pedal housing 100. Then, as the brake housing 700 is rotated counter-clockwise through the opening (not shown) in the base 102 and into the interior cavity 140 of the housing 100, the locking tabs 718 defined on the exterior of the respective side walls 705 and the back wall 708 of the friction assembly housing 702 slide against the respective side walls 103 and 104 and the back wall 106 of the pedal housing 100. As the friction assembly 700 is pressed further into the friction generating cavity 140 of the pedal housing 100, it reaches a stop position where the respective locking tabs 718 snap into respective cavities or recesses (not shown) defined in the interior surface of the respective pedal housing walls 103, 104, and 106 for securely clipping and retaining the friction generating assembly 700 in the friction generating assembly cavity 140.

The use of friction generating assembly 700 has many advantages. Because friction generating assembly 700 is a modular self-contained friction generating unit, it can be used with pedal housings 100 and pedal arms 50 of different shapes and sizes due to the different configurations of vehicle floors, vehicle firewalls, mounting holes, pedal locations and connector mounting locations.

Stated another way, because friction generating assembly 700 is a modular self-contained friction generating unit, the design of friction generating assembly 700 can remain constant while the shape and size of housing 100 and pedal arm 50 may be customized for each vehicle application as necessary.

A description of the operation of the pedal assembly 20 and, more specifically, the friction generating assembly 700 thereof, follows with reference to FIGS. 2 and 6. Pedal arm 50 can be depressed by a user and moved in the counter-clockwise direction 70 (to accelerate) or the pedal arm 50 can be released and moved in the clockwise direction 72 (to decelerate). As pedal arm 50 is depressed and moves in the direction 70, the pedal arm 50 rotates downwardly in the direction of the housing base wall 102 which, in turn, causes the pedal arm cam lobe 62 to engage with or press against the distal end surface 799 of the actuator 780 of friction generating assembly 700. Cam lobe 62 and camming surface 799 translate the rotary motion of pedal arm 50 into the linear motion of actuator 780.

As pedal arm 50 is depressed further, the actuator 780 is slid and moved inwardly into the cavity 710 of the brake housing 702 of friction generating assembly 700 in direction 779 which initially forces the actuator exterior wedge surfaces 795 and 796 into contact with the respective interior surfaces 763d and 764d of respective paddles 763a and 764a of the legs 763 and 764 of the brake pad 760 and then into contact with the respective interior angled surfaces 770 and 768 of the respective legs 763 and 764 of the brake pad 760 which, in turn, forces the legs 763 and 764 to flex and move outwardly in opposite directions away from each other into contact with the respective interior surfaces 731 and 732 of the opposed side walls 705 of the housing 702 of friction generating assembly 700 which, in turn, causes an increase in the normal contact or frictional forces between the arm contact surfaces 766 and 767 and the housing interior braking surfaces 731 and 732.

The frictional force generated between the brake pad contact surfaces 766 and 767 and the housing braking surfaces 731 and 732 and the force required to move the actuator 780 increases as the actuator 780 is moved further inwardly in the housing cavity 710 in the direction 779. The flexible rib member 762 of the brake pad 760 advantageously allows each of the legs 763 and 764 to flex independently of each other and to be independently self-aligned with the respective interior housing surfaces 731 and 732 so as to allow the even distribution of loads applied to the legs 763 and 764 by the actuator 780. The flexible rib member 762 additionally advantageously reduces friction loss following wear by minimizing the bending stresses in the respective legs 763 and 764 which negatively affect the force-generating loads.

The resulting drag and friction between the leg contact surfaces 766 and 767 and the housing interior braking surfaces 731 and 732 resists the movement of the pedal arm 50 in the direction 70 and can be felt by the person or user depressing the pedal arm 50.

At the same time that pedal arm 50 is moved in first direction 70 (to accelerate), the spring force within compression springs 750 and 754 increases as springs 750 and 754 are compressed between the brake pad 760 and the back wall 708 of the brake housing 702. The increased spring force urges the brake pad 760 towards or into the actuator 780 into a relationship wherein the brake pad arms 763 and 764 are wedged against the actuator wedge surfaces 795 and 796, respectively.

The effect of the continued depression of the pedal arm 50 and inward movement of the actuator 780 leads to an increasing normal force exerted by the leg contact surfaces 766 and 767 against the housing interior braking surfaces 731 and 732. A friction force between the leg contact surfaces 766 and 767 and the housing interior braking surfaces 731 and 732 is defined by the coefficient of dynamic friction multiplied by the normal force. As the normal force increases with increasing applied force at the pedal arm 50, the friction force accordingly increases. The driver feels this increase in his/her foot at pedal arm 50. The friction force opposes the applied force as the pedal arm 50 is depressed and subtracts from the spring force as the pedal arm 50 is returned in the direction 72 toward its idle position.

When force on the pedal arm 50 is reduced or the pedal arm 50 is released and moves in the direction 72, the pedal arm 50 rotates upwardly and the springs 750 and 754 decompress to urge brake pad 760 to move the actuator 780 in direction 778 outwardly from housing 702 to return the pedal arm 50 to a rest or idle position.

As actuator 780 moves in the direction 778 away from the back wall 708 of the friction module housing 702, the frictional or drag forces between the brake pad leg contact surfaces 766 and 767 and the housing interior braking surfaces 731 and 732 of the housing 702 is reduced and decreases, but does not eliminate, the pressure applied to the housing walls 705 inasmuch as some drag or friction still remains between the brake pad leg contact surfaces 766 and 767 and the housing braking surfaces 731 and 732 as the pedal arm 50 moves.

Further, as the brake pad 760 and actuator 780 move in direction 778, a slight wedging effect will still occur between the brake pad 760 and the actuator 780. More specifically, the angled surfaces 768 and 770 of the legs 764 and 763 respectively of brake pad 760 are pressed into contact with the wedge surfaces 795 and 796 of the actuator 780 forcing the legs 763 and 764 to bend and be moved outwardly away from each other. In this manner, a low amount of drag force is generated between the leg contact surfaces 766 and 767 and the housing interior braking surfaces 731 and 732, respectively, as actuator 780 moves in direction 778.

The resulting drag between the brake pad leg contact surfaces 766 and 767 and housing interior braking surfaces 731 and 732 slows the movement of the pedal arm 50 in the direction 72 and can be felt by the foot of the user. Further reduction in force on the pedal arm 50 results in pedal arm 50 moving to an idle engine position.

Thus, the sliding motion of actuator 780 into the brake pad 760 is gradual and can be described as a “wedging” effect that either increases or decreases the force urging the brake pad leg contact surfaces 766 and 767 into the housing interior braking surfaces 731 and 732. This force is directionally dependent and the force has hysteresis.

The force required to depress the pedal arm 50 is not equal to the force required to return the pedal arm 50 to its idle position. More force is required to depress the pedal arm 50 due to the friction generated between the brake pad leg contact surfaces 766 and 767 and the housing interior braking surfaces 731 and 732 than is required to return the pedal arm 50 to its idle position. The forces required to return the pedal arm 50 to its idle position are supplied by the decompression of springs 750 and 754. Hysteresis in pedal arm force is desirable in that it approximates the feel of a conventional mechanically-linked accelerator pedal.

The friction force adds to the spring force during depression of the pedal arm 50 and the friction force subtracts from the spring force as the pedal arm 50 is released or returned toward its idle position.

Numerous variations and modifications of the embodiments described above may be effected without departing from the spirit and scope of the novel features of the invention. It is to be understood that no limitations with respect to the pedal assembly and friction generating assembly illustrated herein are intended or should be inferred. It is, of course, intended to cover by the appended claims all such modifications as fall within the scope of the claims.

For example, while the elements of the friction generating assembly have been described as comprising part of a separate module or cartridge adapted to be snapped into the pedal housing, it is understood that the invention likewise encompasses the use of those elements as part of a friction generating assembly which is unitary or molded with the pedal housing.

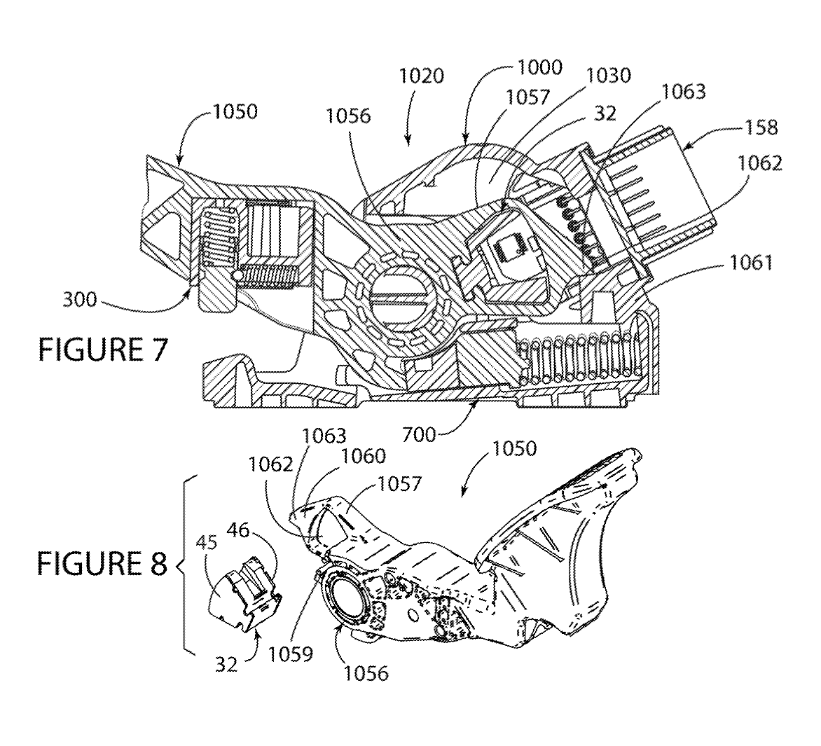

For another example, and as shown in FIGS. 7 and 8, the invention encompasses the alternate pedal assembly 1020 which includes an alternate embodiment of a pedal housing 1000 and an alternate embodiment of a pedal arm 1050. All of the other elements of the pedal assembly 1020, including the magnet assembly 32, the kickdown assembly 300, the friction generating module 700, and the sensor assembly 158 are the same as in the pedal assembly 20 shown in FIGS. 1 and 2, and thus the earlier description of the structure and operation thereof is incorporated herein by reference with respect to the pedal assembly 1020.

The pedal housing 1000 shown in FIG. 7 differs in structure from the pedal housing 100 of the pedal assembly 20 shown in FIGS. 1 and 2 in that the pedal housing 1000 includes a back wall 1061 with an interior surface which includes an interior ledge 1062 protruding and extending inwardly into the sensor cavity 1030 defined in the interior of the pedal housing 1000.

The pedal housing 1000 is otherwise similar in structure to the pedal housing 100 of the pedal assembly 20 and thus the earlier description of the structure and elements of the pedal housing 100 is incorporated and applicable herein by reference with respect to the pedal housing 1000 of pedal assembly 1020.

The pedal arm 1050 of pedal assembly 1020 differs in structure from the pedal arm 50 of pedal assembly 20 shown in FIGS. 1 and 2 in that the pedal arm 1050 includes a rounded drum 1056 having an elongated arm plate 1057 extending unitarily outwardly from the front exterior surface of the drum 1056 in a relationship wherein the exterior surface (not shown) of the plate 1057 is disposed generally co-planar with the side surface (not shown) of the pedal arm 1050 and the magnet assembly bracket 1059 extending outwardly from the front exterior surface of the drum 1056 is disposed generally opposite and abutting against the interior surface 1060 of the plate 1057. The plate 1057 additionally defines a cavity or recess 1062 extending into the interior thereof from the interior surface 1060. The plate 1057 terminates in a distal finger 1063.

The magnet assembly 32 is coupled to the bracket 1059 in the same manner as described earlier with respect to the bracket 59 of the pedal arm 50 shown in FIGS. 1 and 2 into a relationship (not shown) wherein one of the pole pieces 46 and a portion of the magnet 32 are fitted and extended into the cavity 1062 defined in the arm plate 1057.

Additionally, and as shown in FIG. 7, the pedal arm plate 1057 extends through the interior cavity 1030 of the pedal housing 1000 in the direction of the back wall 1061 of the pedal housing 1000 and the distal finger 1063 is adapted to abut against the ledge 1062 defined on the interior surface of the back wall 1061 of the pedal housing 1000 and limit or stop the counter-clockwise rotation of the pedal arm 1050 relative to the pedal housing 1000 when the pedal arm 1050 is returned to its idle position during use.

The pedal arm 1050 is otherwise similar in structure to the pedal arm 50 of the pedal assembly 20, and thus the earlier description of the structure, elements, and operation of the pedal arm 50 is incorporated herein by reference with respect to the pedal arm 1050.

What is claimed is:

1. A pedal assembly comprising:
a housing;
a pedal arm coupled to the housing;
a friction generating assembly associated with the housing and including:
an actuator mounted adjacent the pedal arm, the actuator being adapted to be moved by the pedal arm as the pedal arm is depressed;
a brake pad having a pair of legs interconnected by a flexible and arcuate rib member, each of the legs including an interior and an exterior contact surface, the actuator being adapted to abut against the interior contact surface of the pair of legs and flex the pair of legs and the exterior contact surface thereof into abutting frictional abutting relationship with a braking surface; and
a spring contacting the brake pad for biasing the pedal arm; and
a sensor responsive to movement of the pedal arm for providing an electrical signal that is representative of pedal position.

2. The pedal assembly in accordance with claim 1, wherein each of the pair of legs of the brake pad includes a distal foot projecting outwardly therefrom, the actuator being adapted to abut against the distal foot on each of the legs and flex the pair of legs outwardly away from each other and into contact with the braking surface.

3. The pedal assembly in accordance with claim 1, further comprising a friction generating assembly housing which defines the braking surface and receives the actuator and the brake pad for linear movement therein and the spring for compression therein, the friction generating assembly housing being coupled to the pedal assembly housing.

4. The pedal assembly in accordance with claim 3, wherein the pedal assembly housing defines an interior cavity and includes a base defining an opening in a lower surface thereof, the friction generating assembly being in the form of a separate cartridge fitted into the interior cavity of the pedal assembly housing through the opening in the base of the pedal assembly housing.

5. The pedal assembly in accordance with claim 1, wherein the pedal assembly housing includes a shell defining an interior cavity and the shell defines an opening into the interior cavity, the pedal assembly further comprising a connector assembly extending through the opening in the shell and into the interior cavity and including a pair of clip arms for clipping the connector assembly to the shell of the pedal assembly.

6. The pedal assembly in accordance with claim 1, wherein the pedal assembly housing includes a shell defining an interior cavity and a back wall including an interior surface defining a ledge, the pedal arm including a drum and an elongated arm protruding outwardly therefrom and adapted to abut against the ledge defined on the interior surface of the back wall of the shell for limiting the rotation of the pedal arm relative to the pedal assembly housing.

7. The pedal assembly in accordance with claim 1, wherein the rib member is generally u-shaped.

8. A pedal assembly comprising:
a housing including a shell defining an interior cavity and at least first, second, and third openings;
a pedal arm including a drum extending through the first opening in the shell and into the interior cavity of the housing;
a sensor assembly extending through the second opening in the shell and into the interior cavity of the housing; and
a friction generating cartridge extending through the third opening in the shell and into the interior cavity of the housing.

9. The pedal assembly of claim 8, wherein the friction generating cartridge includes:
a brake pad seated and moveable linearly in the friction generating cartridge and comprising a pair of legs interconnected by a flexible and arcuate rib member, each of the legs including an outside contact surface adapted to contact an interior braking surface of the friction generating cartridge;
at least one compressible spring seated in the friction generating cartridge and adapted to engage against the brake pad; and
an actuator seated and moveable linearly in the friction generating cartridge and adapted to engage against an inside surface of the pair of legs of the brake pad for moving the legs of the brake pad outwardly into contact with the interior braking surface of the friction generating cartridge, the brake pad being seated in the friction generating cartridge between the spring and the actuator and the actuator being adapted to contact the pedal arm.

10. The pedal assembly of claim 9, wherein the rib member of the brake pad is generally U-shaped.

11. The pedal assembly of claim 9, wherein the shell includes a back wall and the second opening is defined in the back wall, the sensor assembly including a clip adapted to engage with the back wall of the shell for securing the sensor assembly to the housing.

12. The pedal assembly of claim 9, wherein the shell includes a back wall having an interior surface defining a ledge, the drum including an elongate arm projecting outwardly therefrom into the interior cavity of the housing and into abutting contact with the ledge defined on the back wall of the shell to limit the rotation of the pedal arm relative to the housing.
